(19) United States
(12) Patent Application Publication
(10) Pub. No.: US 2009/0040181 A1
(43) Pub. Date: Feb. 12, 2009

(54) System and Method For Magnetic Hand Controller

(76) Inventors: Lawrence Darnell, Cypress, TX (US); Christopher Horvath, Irvine, CA (US); Bruno Lassalas, Irvine, CA (US)

Correspondence Address: ALCON, IP LEGAL, TB4-8, 6201 SOUTH FREEWAY, FORT WORTH, TX, 76134, US

(21) Appl. No.: 11/836,426

(22) Filed: Aug. 9, 2007

(51) Int. Cl. G06F 3/033

(52) U.S. Cl. 345/161

(57) ABSTRACT

Embodiments provide a system and method for magnetic hand controllers. An embodiment of a magnetic hand controller can include a base portion comprising a base magnet, a hand control portion spaced from and movable relative to the base portion, the hand control portion comprising a hand control and a hand control magnet coupled to the hand control and oriented so that the hand control magnet is attracted to the base magnet. The hand control portion may be coupled to a device such that a user may control the device by moving the hand control.

### BACKGROUND

The present invention relates to controllers. More particularly, embodiments relate to magnetic controllers. Even more particularly, embodiments relate to systems and methods for magnetic hand controllers.

A micromanipulator associated with a microscope or other precision instrument may be used to precisely adjust various components associated with the microscope or other precision instrument. In some cases, a hand controller such as a joystick controller may be used to control the micromanipulator such that a user can control the micromanipulator by hand through the movement of a joystick. Embodiments of a joystick controller may be used, for example, to adjust a mirror to focus a laser beam associated with a microscope so as to illuminate a desired portion of tissue, a sample or anything else.

The joystick handle of a joystick controller is often held and centered using springs or o-rings. Existing joystick controllers typically employ elastomeric springs in the form of commercial o-rings to provide restorative force for centering. The o-rings are situated between flat surfaces, one fixed, one movable. As a further example, a spring is used to attach a joystick handle to a base such that it provides a restorative force to center. The movement of the joystick handle may be erratic or uneven and feel mushy to a user. Additionally, spring or o-ring based systems may exhibit appreciable drift from center.

In addition to the problems associated with hysteresis, drift and feel, current spring and o-ring based systems lack adjustability. For example, the movement resistance of the joystick handle is typically mechanically fixed such that there is no easy or precise way to adjust the movement resistance of the joystick handle. Likewise, the center position of the joystick handle may be mechanically fixed such that there is no easy or precise way to adjust the center position of the joystick handle.

### SUMMARY OF THE INVENTION

Embodiments provide a method and system for a magnetic hand controller. The system can comprise a base portion comprising a base magnet and a hand control portion spaced from and movable relative to the base portion, the hand control portion comprising a hand control operable to move the hand control portion relative to the base portion and a hand control magnet coupled to the hand control. The hand control magnet can be oriented so that the hand control magnet is attracted to the base magnet. A micromanipulator may be coupled to the hand control portion such that the micromanipulator can be controlled by moving the hand control. Adjustment mechanisms may adjust either the position of the base magnet or the handle magnet along one or more axes.

Embodiments provide advantages over the prior art in that the attraction between the base magnet and the hand control magnet holds the hand control portion and centers the hand control portion at a center position. Furthermore, the attraction between the base magnet and the hand control magnet provides a substantially even resistance to the movement of the hand control by a user, ensuring that a user experiences smooth hand control movement. In some embodiments, the user may adjust the position of the magnets so as to adjust the location of the center position of the hand control. The user may further be able to adjust the force of attraction between the magnets so as to adjust the movement resistance of the hand control.

### BRIEF DESCRIPTION OF THE FIGURES

A more complete understanding of embodiments and the advantages thereof may be acquired by referring to the following description, taken in conjunction with the accompanying drawings in which like reference numbers indicate like features and wherein:

FIG. 1 is a diagrammatic representation of one example of a microscope apparatus;

FIG. 2 is a diagrammatic representation of a view of one embodiment of a micromanipulator attachment;

FIG. 3A is a diagrammatic representation of another view of one embodiment of a micromanipulator attachment;

FIG. 3B is a diagrammatic representation of a view of one embodiment of a portion of a micromanipulator attachment.

FIG. 3C is a diagrammatic representation of a view of one embodiment of a portion of a micromanipulator attachment.

FIG. 4 is a diagrammatic representation of a view of one embodiment of a portion of a micromanipulator attachment;

FIG. 5 is a diagrammatic representation of a view of one embodiment of a micromanipulator attachment;

FIG. 6 is a diagrammatic representation of one embodiment of a magnetic joystick controller; and

FIG. 7 is a diagrammatic representation of a view of one embodiment of a portion of a micromanipulator attachment.

### DETAILED DESCRIPTION

Embodiments are illustrated in the FIGURES, like numerals being used to refer to like and corresponding parts of the various drawings.

A magnetic hand controller may be used to control any number of devices such as various types of micromanipulators. A magnetic hand controller may use magnetic fields to hold and center the hand control (e.g. comprising a joystick handle, a knob, a thumb controller, or any other type of hand controllable mechanism) of the magnetic hand controller. A micromanipulator controlled with the aid of a magnetic hand controller may be used in conjunction with a variety of high precision devices. For purposes of explanation, a type of magnetic hand controller, namely a magnetic joystick controller, will be described. For example, a micromanipulator controlled by a magnetic joystick controller may be used in conjunction with a microscope. More specifically, a magnetic joystick controller may be used to control a micromanipulator through the movement of the joystick handle such that the micromanipulator adjusts a mirror to direct a laser beam so as to illuminate a desired portion of tissue, a sample, or anything else.

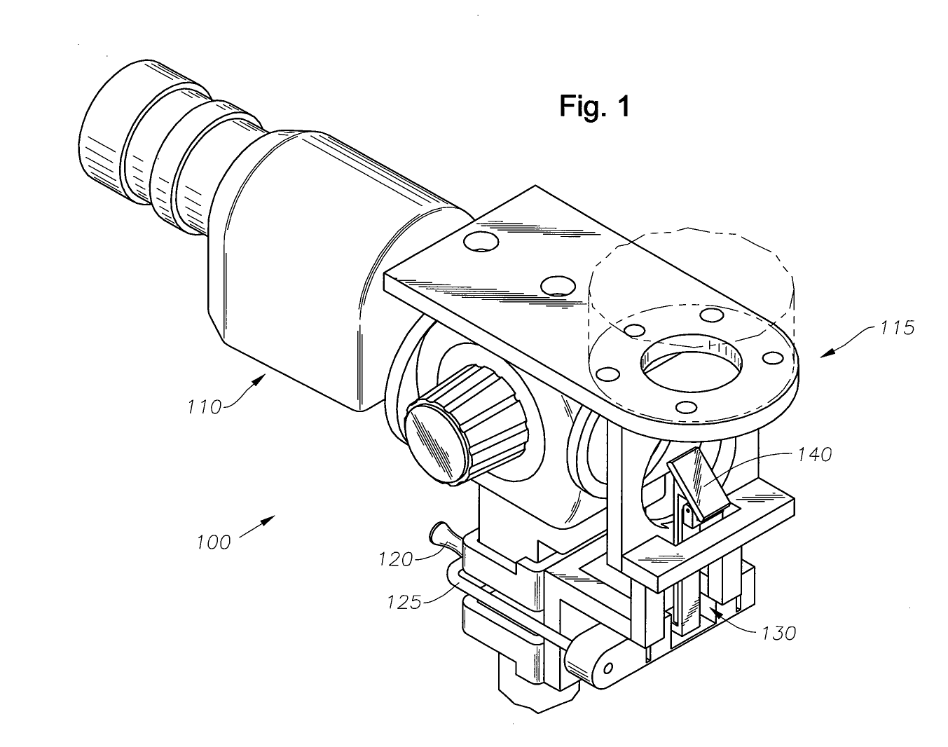

FIG. 1 is a diagrammatic representation of a microscope apparatus 100. Microscope apparatus 100 comprises microscope device 110 having micromanipulator attachment 115. Attachment 115, which can include magnetic joystick controller 120, micromanipulator 130 and mirror 140, is mounted to microscope device 110. Magnetic joystick controller 120 is mechanically coupled to micromanipulator 130 by control arm 125. Micromanipulator 130 is coupled to mirror 140 and may be used to adjust mirror 140 to direct a laser beam or other illumination source. Consequently, magnetic joystick controller 120 can be used to control micromanipulator 130 to adjust the orientation of mirror 140.

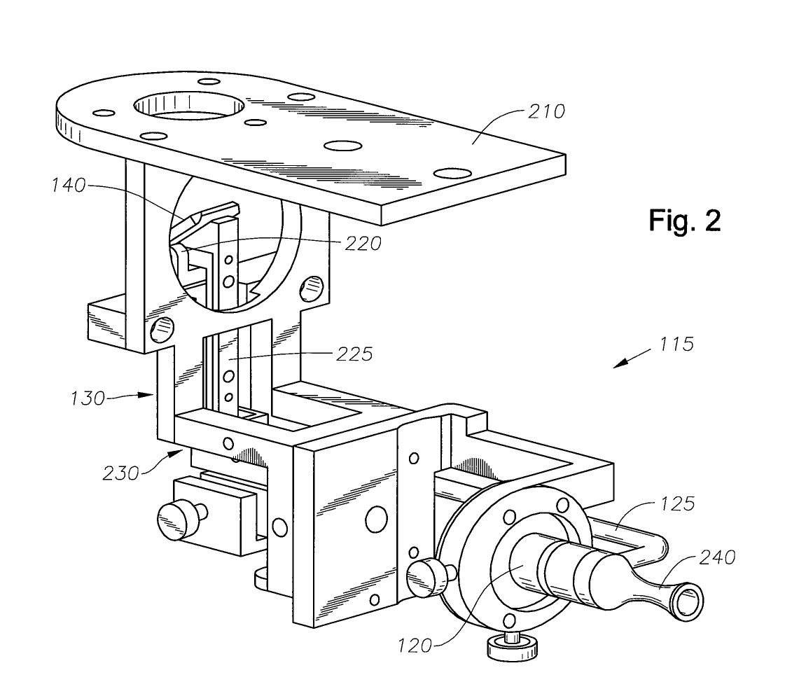

FIG. 2 is a diagrammatic representation of a view of micromanipulator attachment 115. Micromanipulator attachment 115 of FIG. 2 comprises magnetic joystick controller 120, micromanipulator 130 and mirror 140. Micromanipulator attachment 115 may be mounted to a microscope or other precision device utilizing mount 210. Micromanipulator 130 comprises mirror pivot block 220 and controller pivot block 230 which are coupled by linkage 225. Mirror 140 is mounted to linkage 225. Mirror pivot block 220 comprises multiple pivots, forming a gimbal (i.e., a structure that allows rotation about multiple axes) which allows linkage 225, and thus attached mirror 140, to move with regard to multiple axes such that the orientation of mirror 140 can be adjusted with regard to multiple axes. Mirror pivot block 220 is mechanically coupled to linkage 225 by means of a horizontal pivot, wherein linkage 225 comprises one or more lever arms and is mechanically coupled to controller pivot block 230 which comprises one or more pivots.

In turn, controller pivot block 230 is mechanically coupled to magnetic joystick controller 120. More specifically, controller pivot block 230 is mechanically coupled to control arm 125, which in turn is mechanically coupled to joystick handle 240 of magnetic joystick controller 120 such that moving joystick handle 240 results in the displacement of one or more pivots comprising controller pivot block 230. Through the above-described couplings, magnetic joystick controller 120 is coupled to mirror 140 and can be used to adjust the orientation of mirror 140. For example, if joystick handle 240 is moved up, controller pivot block 230 can pivot about a horizontal axis, causing a lever arm comprising linkage 225 to move vertically. This in turn can cause mirror 140 to move about its horizontal axis. If joystick handle 240 is moved horizontally, controller pivot block can pivot about a vertical axis to assert a horizontal force on a lever arm of linkage 225. This will cause mirror 140 to rotate about a vertical axis. The gimbal motion of mirror pivot block 220 and mirror 140 allows mirror 140 to be placed in a variety of orientations.

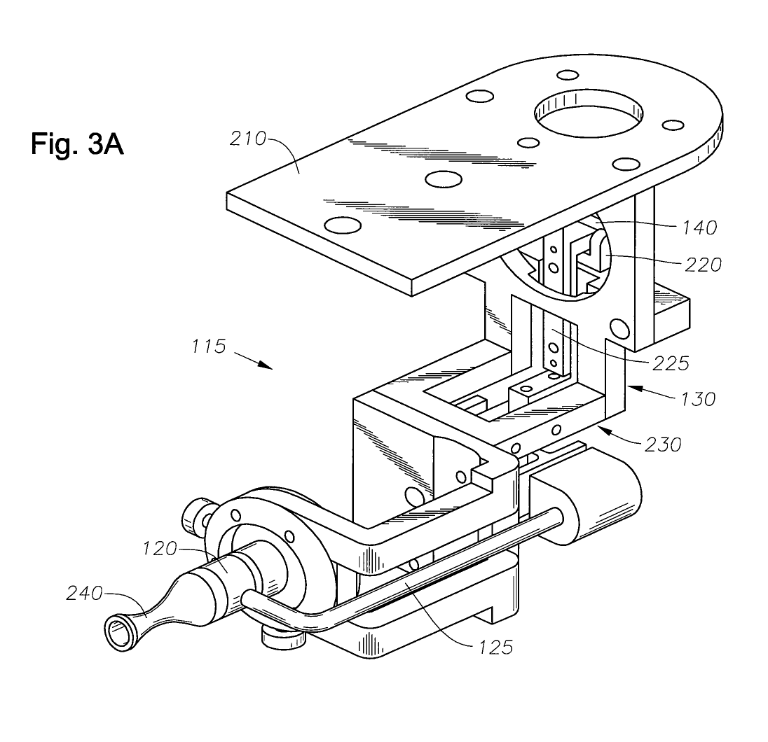

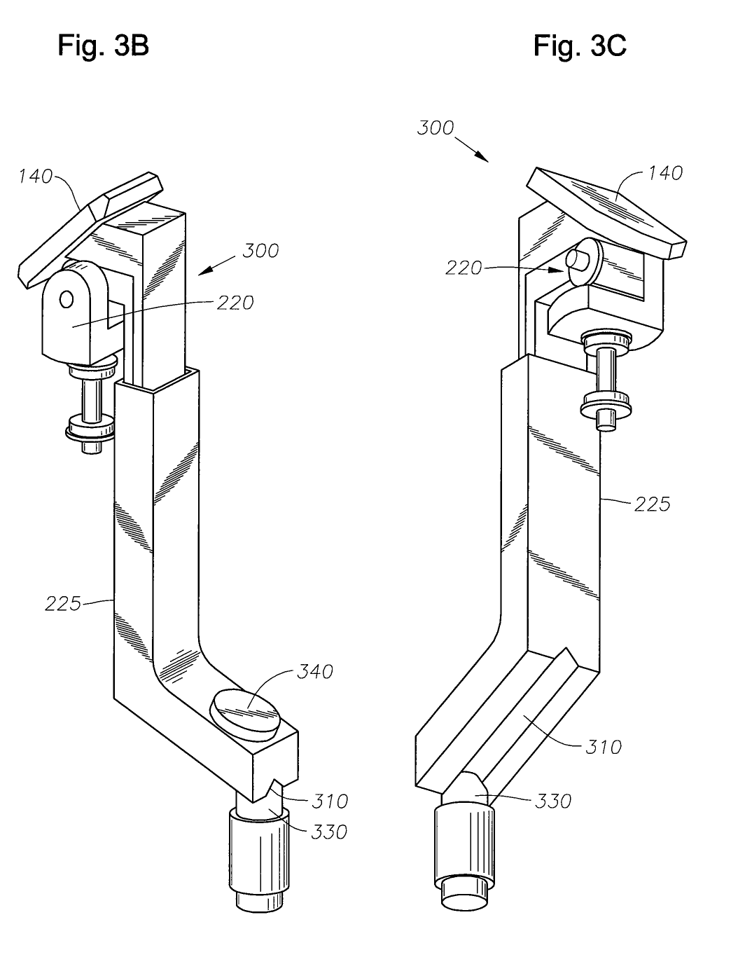

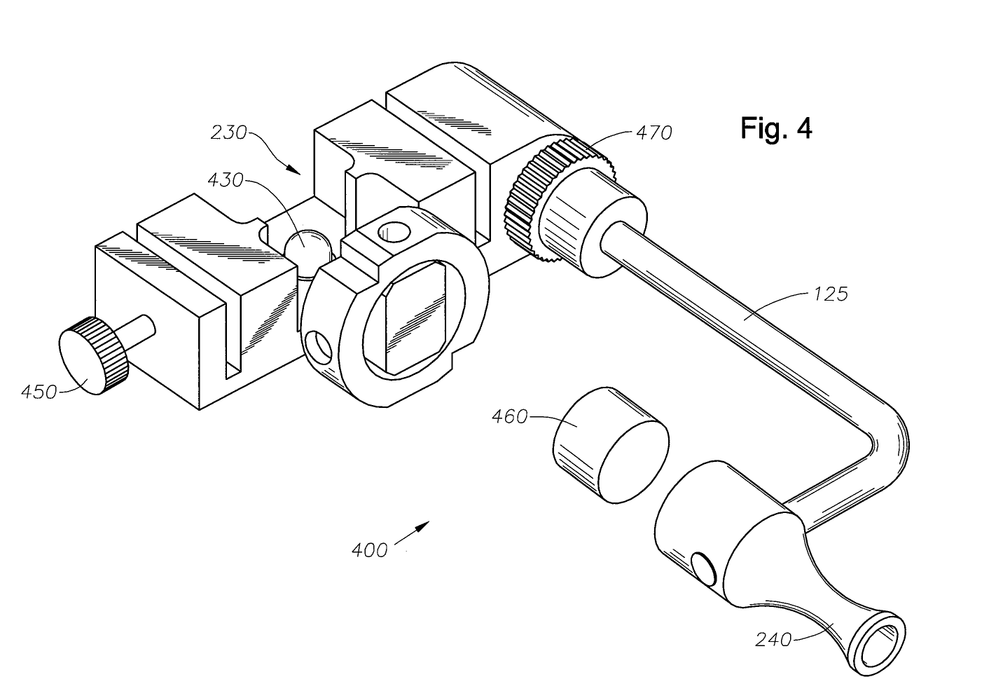

FIG. 3A is a diagrammatic representation of another view of micromanipulator attachment 115. Micromanipulator attachment 115 of FIG. 3A comprises magnetic joystick controller 120, micromanipulator 130 and mirror 140. Micromanipulator attachment 115 may be mounted to a microscope or other precision device utilizing mount 210. Magnetic joystick controller 120 comprises joystick handle 240 which is mechanically coupled to controller pivot block 230 by control arm 125. Controller pivot block 230 comprises multiple pivots, forming a gimbal which allows control arm 125 to move with regard to multiple axes. Moving joystick handle 240 moves control arm 125, resulting in the displacement of one or more pivots comprising controller pivot block 230, which in turn causes a rotational movement in one of the lever arms comprising linkage 225. Rotational movement in the lever arms comprising linkage 225 causes mirror 140 to move about the axes established by mirror pivot block 220.

FIGS. 3B and 3C are diagrammatic representations of an embodiment of portion 300 of micromanipulator attachment 115. In FIGS. 3B and 3C, mirror 140 is mounted to linkage 225 and linkage 225 is mechanically coupled to mirror pivot block 220 which allows linkage 225 to be moved about multiple axes, thus allowing for the orientation of mirror 140 with regard to multiple axes. Linkage 225 may comprise engagement 310 (i.e. a v-groove) which engages pivot 330 (which may be a part of, for example, controller pivot block 230 of FIGS. 2 and 3A). Linkage 225 may further comprise a coupling magnet 340 located near engagement 310 as shown in FIG. 3B. Pivot 330 is shaped such that it engages engagement 310 of linkage 225. Pivot 330 is loaded in engagement 310 by a magnetic force exerted on it by coupling magnet 340 such that the magnetic force between pivot 330 and coupling magnet 340 acts as a small pre-load spring coupling pivot 330 and engagement 310. Because pivot 330 may be part of a controller pivot block and mechanically coupled to and controlled by a magnetic joystick controller, movement of the joystick handle of the magnetic joystick controller may control the movement of pivot 330 and, through the engagement of pivot 330 with engagement 310 of linkage 225, the movement of linkage 225 about one or more axes and thus the orientation of mirror 140 with regard to one or more axes.

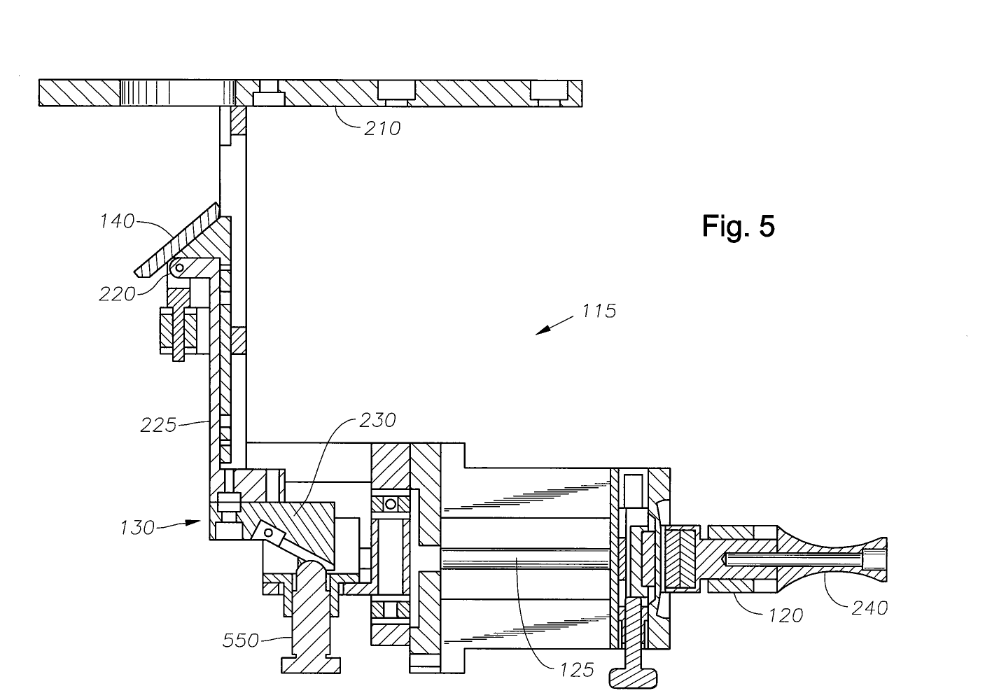

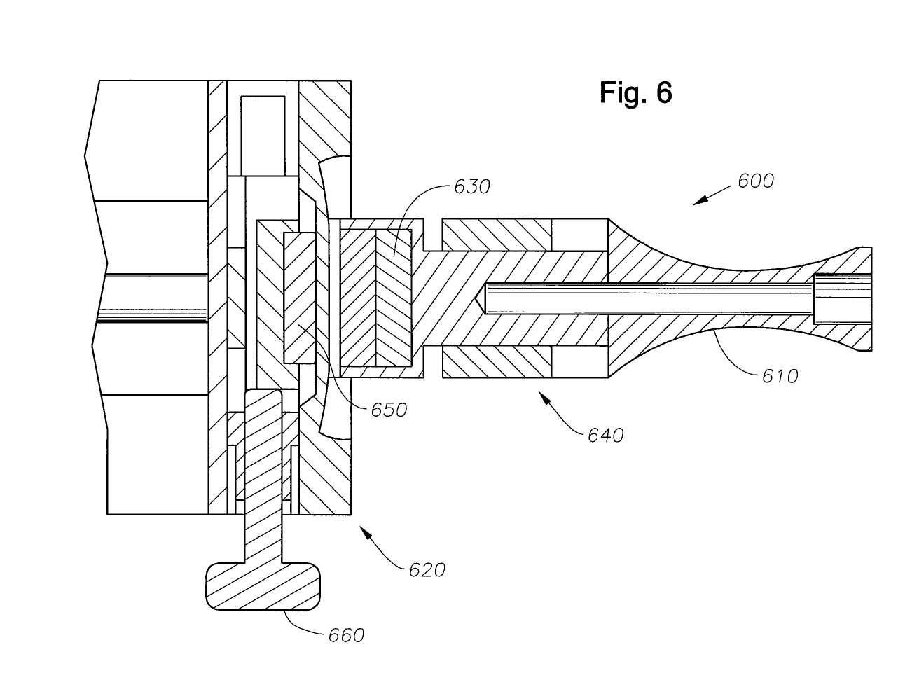

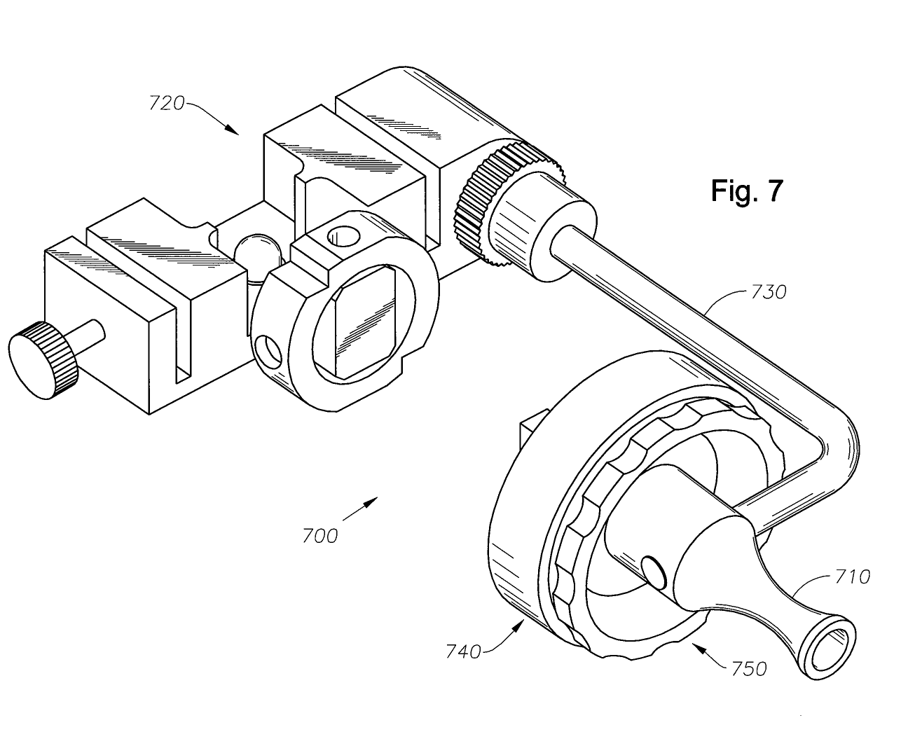

FIG. 4 is a diagrammatic representation of a portion 400 of micromanipulator attachment 115. In portion 400, joystick handle 240 is mechanically coupled to controller pivot block 230 by control arm 125. The horizontal position of controller pivot block 230 can be adjusted via adjustment 450. Adjustment 450 can be a screw pin, actuator or other mechanism that can cause translation of controller pivot block 230. Because the displacement of a pivot (e.g. pivot 430) results in a corresponding translational movement in the position of a lever arm, adjustment 450 may be used to adjust the relative position of a lever arm and thus the orientation of a mirror mechanically coupled to the lever arm through a pivot, e.g. a pivot of a mirror pivot block. Features 460 and 470 will be discussed below after the discussion of FIGS. 5 and 6.

FIG. 5 is a diagrammatic representation of a view of micromanipulator attachment 115. Micromanipulator attachment 115 of FIG. 5 may be mounted to a microscope or other precision device utilizing mount 210. Micromanipulator 130 comprises mirror pivot block 220 and controller pivot block 230 which are mechanically coupled by linkage 225. Magnetic joystick controller 120 is coupled to controller pivot block 230 of micromanipulator 130 via control arm 125 such that moving joystick handle 240 of magnetic joystick controller 120 displaces one or more pivots in controller pivot block 230. In turn, controller pivot block 230 is mechanically coupled to linkage 225 such that the curvilinear displacement of a pivot in controller pivot block 230 causes rotational movement in a corresponding lever arm comprising linkage 225. Linkage 225 is mechanically coupled to mirror pivot block 220 such that the rotational movement of a lever arm comprising linkage 225 causes the movement of mirror 140 about the horizontal and vertical axes established by mirror pivot block 220. Thus, through a plurality of mechanical couplings, movements of joystick handle 240 results in adjustments in the orientation of mirror 140.

Adjustment 550 may be used to adjust the vertical position of a lever arm comprising linkage 225. Because mirror 140 is coupled to the lever arms of linkage 225 through mirror pivot block 220, a change in the position of a lever arm through the adjustment of adjustment 550 adjusts the orientation of mirror 140 along an axis. Thus, adjustment 550 may be used to orient mirror 140. Adjustment 550 can include a screw, pin actuator or other mechanism to provide translation. According to one embodiment, adjustment 550 and adjustment 450 (shown in FIG. 4) can be used to roughly establish a starting orientation for mirror 140. The starting orientation of the mirror can be referred to as the center position as it corresponds to the starting orientation (or 0,0 placement as described by a Cartesian coordinate system) of the laser for a procedure.

Movement of the mirror from its starting orientation can be achieved through movement of joystick handle 240. Magnetic fields may be used to hold and center a hand control (e.g. a joystick handle or any other type of hand controllable mechanism) of a magnetic hand controller such that a magnetic field impels the hand control towards a center position and provides a consistent and even resistance to hand control movements. Because the magnetic field provides a consistent and even resistance to hand control movements, a user will feel even resistance as the user moves the hand control.

In one embodiment, a hand control magnet may be positioned at or near an end of a hand control to form a hand control portion which can be positioned over the base portion of the magnetic hand controller such that the hand control magnet is positioned over a base magnet contained in the base portion. The two magnets may be oriented such that an attractive magnetic force exists between them (e.g. the north pole of one magnet faces the south pole of the other magnet). The magnetic force between the two magnets may center the hand control over the base magnet and provide a consistent and even resistance to hand control movements. In one embodiment, the two magnets may be separated by an air gap, the width of which may be adjusted to increase or decrease the force of the magnetic attraction between the magnets and thus the resistance to the movement of the hand control.

FIG. 6 is a diagrammatic representation of one embodiment of a magnetic joystick controller 600. Magnetic joystick controller 600 is comprised of handle 640 portion and base 620 which includes base magnet 650. Joystick handle 610 is coupled to hand control magnet 630 to form handle portion 640 which is positioned over base 620 such that hand control magnet 630 is positioned over base magnet 650 and is spaced from and movable relative to base 620. In one embodiment, hand control magnet 630 is separated from base magnet 650 by an air gap. Hand control magnet 630 and base magnet 650 are oriented such that the magnetic force between them is attractive and hand control magnet 630 is attracted to base magnet 650. Thus, when a user moves joystick handle 610, the attraction between hand control magnet 630 and base magnet 650 will provide an even resistance to the movement of handle portion 640. Furthermore, the magnetic attraction between hand control magnet 630 and base magnet 650 will impel handle portion 640 to a consistent center position.

In embodiments of magnetic joystick controller 600, hand control magnet 630 or base magnet 650 may be a cylinder ⅛ inch thick and ½ inch in diameter. Magnets used in magnetic joystick controller 600 may be magnets which generate relatively strong magnetic fields, such as neodymium magnets. While magnetic joystick controller 600 has been described with regard to two magnets, multiple magnets may be used in, for example, one or more arrays. For example, base magnet 650 may comprise an array of magnets which may be arranged in one or more configurations (e.g. in a circular array). Similarly, hand control magnet 630 may comprise multiple magnets which, in one embodiment, may be stacked to increase or decrease the strength of hand control magnet 630. While specific examples of magnets are provided above, any suitable shape and strength of magnet may be used.

In further embodiments of magnetic joystick controller 600, hand control magnet 630 or base magnet 650 may be adjusted in the x or y axis to adjust the center position to which the magnetic forces generated by magnets 630 and 650 impel handle portion 640. For example, adjustment 660 may be adjusted such that base magnet 650 is moved along an axis, adjusting the center position to which handle portion 640 is impelled by the magnetic force between hand control magnet 630 and base magnet 650. In one embodiment, adjustment 660 is threaded such that it can be rotated to move base magnet 650 along an axis. A similar adjustment may be used to adjust the center position along a different axis. This, in turn, can adjust the starting position of mirror 140.

To adjust the resistance a user feels to the movement of handle portion 640, the distance between magnets 630 and 650 may be adjusted: increasing the distance between magnets 630 and 650 decreases handle portion 640 movement resistance, whereas decreasing the distance between magnets 630 and 650 increases handle portion 640 movement resistance. In further embodiments of joystick controller 600, magnet 630 or 650 can be electromagnets and the movement resistance of handle portion 640 increased or decreased by increasing or decreasing the current in the electromagnet to increase or decrease the magnetic field and the magnetic force between magnets 630 and 650. An adjustable potentiometer (or any suitable mechanism) can be used to regulate the current in the electromagnet.

Returning to FIG. 4, in portion 400, joystick handle 240 is coupled to pivot block 230 by control arm 125. Joystick handle 240, and thus a hand control magnet comprising joystick handle 240, is separated from position 460 of the base magnet by an air gap. The width of the air gap between joystick handle 240 and position 460 of the base magnet may be adjusted utilizing gap adjustment 470. More specifically, in one embodiment, gap adjustment 470 can be utilized to increase or decrease the position of joystick handle 240 relative to item 460, correspondingly increasing or decreasing the gap between joystick handle 240 and the base magnet, respectively. Gap adjustment 470 can loosen or tighten a friction clasp which grips control arm 125. When the friction clasp is loosened, control arm 125, and thus joystick handle 240, may be raised or lowered, increasing or decreasing the gap between joystick handle 240 and position 460 of the base magnet.

Turning to FIG. 7, FIG. 7 is a diagrammatic representation of a portion 700 of one embodiment of a micromanipulator apparatus. FIG. 7 depicts another system for increasing or decreasing the gap between a base magnet and a hand control magnet. In portion 700, joystick handle 710 is coupled to pivot block 720 of a micromanipulator by control arm 730. Joystick handle 710 hand control magnet is separated from a base magnet in base 740 by an air gap. The width of the air gap between joystick handle 710 and the base magnet in base 740 may be adjusted utilizing gap adjustment 750. More specifically, in one embodiment, gap adjustment 750 can be utilized to increase or decrease the position of the base magnet relative to the hand control magnet comprising joystick handle 710, decreasing or increasing the gap between joystick handle 710 and the base magnet in base 740, respectively. In one embodiment, gap adjustment 750 is threaded so that it can be rotated to raise or lower the base magnet. In one embodiment of base 740, the base magnet is coupled to base 740 via a slide mechanism which allows the base magnet to move along one or more axes relative to base 740. For example, the base magnet may be moved along x, y and z axes relative to base 740 such that the center, or zero, position is adjusted or the gap between the base magnet and the hand control magnet is increased or decreased.

Using embodiments described, for example, in FIGS. 1-7, prior to a procedure, a surgeon can set the center laser position by roughly adjusting the x or y orientation of mirror 140 through adjustments 450 (FIG. 4) and 550 (FIG. 5). Both X and Y zero positions can be more finely adjusted using adjustment 660 and a similar adjustment as described in conjunction with FIG. 6 (e.g. the X and Y fine adjustment screws are both shown in FIG. 2). During the procedure, the surgeon can move the position of the laser away from 0,0 by moving the joystick handle. Embodiments of the magnetic joystick controller allow the joystick handle to smoothly and accurately return to its starting or center position.

While embodiments of a magnetic hand controller have been described with regard to producing a mechanical output, it will be understood that this is by way of example and that a magnetic joystick controller may produce electrical signals which may be utilized to control a device, e.g. a micromanipulator. More specifically, in one embodiment, moving the hand control (e.g. a joystick handle) of a magnetic hand controller may produce electrical signals which control one or more electric motors comprising a micromanipulator or other device. In other embodiments, the magnetic hand controller may pneumatically control another device. Furthermore, embodiments of a magnetic hand controller can be used in any device that may be controlled by a hand control.

Although particular embodiments have been described in detail herein, it should be understood that the description is by way of example only and is not to be construed in a limiting sense. It is to be further understood, therefore, that numerous changes in the details of the embodiments described above and additional embodiments will be apparent, and may be made by, persons of ordinary skill in the art having reference to this description. It is contemplated that all such changes and additional embodiments are within scope of the invention as claimed below.

What is claimed is:

1. A system, comprising:
a base portion comprising a base magnet;
a hand control portion spaced from and movable relative to the base portion, the hand control portion comprising:
a hand control operable to move the hand control portion relative to the base portion; and
a hand control magnet coupled to the hand control, the hand control magnet oriented so that the hand control magnet is attracted to the base magnet; and
a micromanipulator coupled to the hand control portion, wherein the micromanipulator is controlled by moving the hand control.

2. The system of claim 1, wherein the hand control is a joystick handle.

3. The system of claim 1, further comprising a base magnet adjustment operable to move the base magnet along an axis relative to the base portion.

4. The system of claim 1, wherein the hand control magnet comprises a neodymium magnet.

5. The system of claim 1, wherein the hand control magnet and the base magnet are separated by an air gap.

6. The system of claim 5, further comprising a gap adjustment mechanism operable to adjust the width of the air gap.

7. The system of claim 1, wherein the base magnet comprises an electromagnet.

8. The system of claim 1, wherein the hand control magnet comprises an electromagnet.

9. A method, comprising:
attaching a base magnet to a base;
attaching a hand control magnet to a hand control;
positioning the hand control over and spaced from the base, wherein the hand control is movable relative to the base and wherein the attached hand control magnet is oriented so that the hand control magnet is attracted to the base magnet; and
coupling the hand control to a micromanipulator.

10. The method of claim 9, wherein the hand control is a joystick handle.

11. The method of claim 9, wherein the base magnet is movable along an axis relative to the base.

12. The method of claim 9, wherein the hand control magnet comprises a neodymium magnet.

13. The method of claim 9, wherein the hand control magnet and the base magnet are separated by an air gap.

14. The method of claim 13, further comprising adjusting the width of the air gap to increase or decrease the force of the attraction of the hand control magnet to the base magnet.

15. The method of claim 9, wherein the base magnet comprises an electromagnet, wherein the strength of the electromagnet is adjustable.

16. The method of claim 9, further comprising moving the hand control to cause the micromanipulator to move a device.

17. A system, comprising:
a base comprising a base magnet and a base magnet adjustment operable to move the base magnet along an axis;
a hand control coupled to a hand control magnet, the hand control spaced from and movable relative to the base and the hand control magnet oriented so that the hand control magnet is attracted to the base magnet, wherein the hand control magnet and the base magnet are separated by a gap; and
a control arm mechanically coupling the hand control to a micromanipulator.

18. The system of claim 17, further comprising a gap adjustment mechanism operable to adjust the width of the gap.

19. The system of claim 17, wherein the hand control magnet comprises a neodymium magnet.

20. The system of claim 17, wherein the hand control magnet comprises two or more cylindrical magnets.
